(19) United States
(12) Patent Application Publication
(10) Pub. No.: US 2012/0240452 A1
(43) Pub. Date: Sep. 27, 2012

(54) PRODUCTION OF BIODIESEL FUELS

(75) Inventors: Kenneth L. Erdoes, JR., Humble, TX (US); Jeffrey L. Bahr, The Woodlands, TX (US)

(73) Assignee: Endicott Biofuels ll, LLC

(21) Appl. No.: 13/427,613

(22) Filed: Mar. 22, 2012

Related U.S. Application Data
(60) Provisional application No. 61/466,520, filed on Mar. 23, 2011.

(51) Int. Cl. C10L 1/19; B01J 19/00; C10L 1/188

(52) U.S. Cl. 44/388; 44/385; 422/129

(57) ABSTRACT

The present invention relates to a process and apparatus for the production of improved biodiesel fuel from feedstocks containing both fatty acids and glycerides by reactive distillation. Specifically, in one embodiment, the present invention relates to the production of improved biodiesel fuels meeting or exceeding the ASTM D6751-10 Specification.

### CROSS-REFERENCE TO RELATED APPLICATIONS

The present application claims benefit of similarly titled U.S. provisional patent application Ser. No. 61/466,520, filed Mar. 23, 2011, which is incorporated by reference herein in its entirety.

### FIELD OF THE INVENTION

The present invention relates to processes for the production of biofuels, such as but not limited to biodiesel fuel, from feedstocks containing a mixture of free fatty acids and glycerides. Specifically, the present invention relates to the production of improved biodiesel fuels meeting or exceeding the ASTM D6751-10 specification through the use of reactive distillation techniques over solid catalysts.

### BACKGROUND

Diesel fuel is a refined petroleum product which is burned in the engines powering most of the world's trains, ships, and large trucks. Petroleum is, of course, a non-renewable resource of finite supply. Acute shortages and dramatic price increases in petroleum and the refined products derived from petroleum have been suffered by industrialized countries during the past quarter-century. Furthermore, diesel engines which run on petroleum based diesel emit relatively high levels of certain pollutants, especially particulates. Accordingly, extensive research effort is now being directed toward replacing some or all petroleum-based diesel fuel with a cleaner-burning fuel derived from a renewable source, such as naturally occurring oils and fats. Generally, oils and fats are composed of triglycerides and free fatty acids. Some oils may also contain small amounts (typically less than a few percent by weight) of mono- and di-glycerides.

Triglycerides are esters of glycerol, CH₂(OH)CH(OH)CH₂(OH), and three fatty acids. Fatty acids are, in turn, aliphatic compounds containing 4 to 24 carbon atoms and having a terminal carboxyl group. Diglycerides are esters of glycerol and two fatty acids, and monoglycerides are esters of glycerol and one fatty acid. Naturally occurring fatty acids, with only minor exceptions, have an even number of carbon atoms and, if any unsaturation is present, the first double bond is generally located between the ninth and tenth carbon atoms. The characteristics of the triglyceride are influenced by the nature of their fatty acid moieties.

Fatty acid alkyl esters, such as methyl esters, have been proven to be an acceptable supplement to or replacement for petroleum-based fuels. Methyl esters are also useful as lubricity additives, food additives, non-edible emulsifiers, and other chemical additives. Methyl esters can be derived from the base component of oils and fats using a number of technologies, such as esterification of fatty acids or transesterification of glycerides. However, both the esterification and transesterification processes have limitations with respect to the type of feedstock that are suitable for use. For instance, transesterification methods suffer in that the reaction generally requires the addition of a homogeneous acid or base catalyst which must be neutralized in the product stream, thereby generating salts and soaps. The neutralization of the catalyst further requires additional wash water, which leads to larger effluent streams. Moreover, while transesterification results in the separation of fatty acid esters from triglycerides, it also results in the production of glycerin, which must then be separated from the fatty acid esters, excess alcohol, salts, and soaps. Furthermore, the use of a strong acid, such as sulfuric acid, typically leads to higher sulfur content in the resulting biodiesel as the acid reacts with the double bonds in the fatty acid chains. Accordingly, conventional transesterification processes require a clean or refined feedstock that is low in free fatty acids and high in glycerides. As a result, transesterification plants are primarily dependent on refined, bleached, deodorized (“RBD”) oil as a feedstock, which generally commands a premium price in the lipid feedstocks market.

Conventional esterification processes are not without drawbacks either. The presence of glycerides in the feedstream greatly reduces the reaction conversion, extends residence times, and engenders throughput limitations. Accordingly, it is generally desirable to utilize “clean” feedstock that is high in free fatty acids and low in glycerides. In addition, the conventional use of homogeneous acid catalysts requires expensive materials, such as glass lined, teflon lined, or exotic material piping (hastelloy, duplex, incoloy) and equipment to neutralize and/or wash the product stream. Further, the alcohol-to-feedstock ratio is generally high due to the equilibrium nature of the reaction vis-à-vis co-production of water.

Generally, many of the commercially available feedstocks, including the most economically advantageous feedstocks, contain both free fatty acids and glycerides, and therefore represent significant challenges to the production of methyl esters using esterification or transesterification independently. Thus, it would be beneficial if biodiesels that meet or exceed the ASTM D6751-10 specification, lubricity additives, food additives, non-edible emulsifiers, and/or other chemical additives could be produced from a feedstock containing both free fatty acids and glycerides.

### SUMMARY

In an effort to overcome some of the problems associated with the production of biodiesel, the present invention employs reactive distillation in combination with specific downstream processes to assist in the production of improved biodiesel fuels that meet or exceed the ASTM D6751-10 specification. The processes disclosed herein are also useful in producing biodiesel from feedstock containing both free fatty acids and glycerides in any concentration.

The present invention provides a continuous process for the production of improved biodiesel fuel from feedstocks containing both glycerides and free fatty acids. In one embodiment, the process combines upstream processing (pre-treatment), reactive distillation over a catalyst capable of catalyzing both the esterification of free fatty acids and the transesterification of glycerides, and downstream processing (post-treatment) to produce fatty acid alkyl esters from low or high free fatty acid content feedstocks derived from animal or vegetable sources. As use herein, a feedstock comprising a “low free fatty acid content” means a feedstock comprising about 5% or less by weight free fatty acids, and a feedstock comprising a “high free fatty acid content” means a feedstock comprising greater than about 5% by weight free fatty acids. Generally, the present invention provides a process that allows an entire feedstock to be utilized with maximum efficiency, highest throughput, lowest capital outlay, and highest quality biofuel (e.g., biodiesel) to be obtained.

In one embodiment, the present invention provides a process wherein a feedstream having both glycerides and free fatty acids is reacted with alcohols by reactive distillation over heterogeneous catalysts to produce fatty acid alkyl esters. It is an object of the present invention to provide a process allowing for enhanced conversion in equilibrium reactions by continuously removing water content with alcohol vapor. It is another object of the present invention to provide a process allowing for enhanced conversion in equilibrium reactions by continuously removing glycerin.

According to one aspect of the present invention, a process for creating a biodiesel fuel meeting or exceeding the ASTM D6751-10 Specification is provided. A feedstream having both fatty acids and glycerides may be reactively distilled with an alcohol feedstream to produce a fatty acid alkyl ester product stream. Glycerin may be removed from the product stream and the temperature is increased such that water and/or at least one volatile material is vaporized and removed from the product stream. At least one biodiesel additive may be incorporated into the product stream such that the product stream is converted into a biodiesel meeting or exceeding the ASTM D6751-10 Specification.

In another embodiment, a process for preparing biodiesel meeting or exceeding biodiesel standard ASTM D6751-10 from a feedstock having free fatty acids and glycerides is provided. An alcohol vapor feedstream and a feedstream having free fatty acids and glycerides may be continuously introduced to a reaction vessel. The reaction vessel includes a reaction zone having a heterogeneous catalyst and a decanting area. The feedstreams are catalytically reacted in the reaction zone within the reaction vessel to produce fatty acid ester, glycerin, and water. Water may be stripped from the reaction vessel with the alcohol vapor and then separated from the alcohol vapor to be recycled to the reaction vessel. Glycerin may be separated from the reaction vessel in the decanting area of the reaction vessel. A fatty acid alkyl ester product stream may be collected and further processed during post-treatment. At least one biodiesel additive may be incorporated into the product stream such that it is converted into a biodiesel meeting or exceeding the ASTM D6751-10 Specification.

In yet another embodiment, a biodiesel fuel is prepared having a water content of less than about 0.050% by volume. In another embodiment, the biodiesel fuel has a kinematic viscosity between about 1.9 and about 4.1 mm²/s. In another embodiment, the biodiesel fuel has a sulfur content less than 500 ppm, preferably less than 15 ppm, more preferably less than 5 ppm and more preferably less than 1 ppm. In another embodiment, the free glycerin content of the biodiesel fuel is less than about 0.020% by weight. In another embodiment, the total glycerin content of the biodiesel is less than about 0.20% by weight.

These and other aspects, objects, features, and embodiments of the present invention will become apparent to those having ordinary skill in the art upon consideration of the following detailed description of illustrative embodiments exemplifying the best mode for carrying out the invention as presently perceived.

### BRIEF DESCRIPTION OF THE DRAWINGS

For a more complete understanding of the exemplary embodiments of the present invention and the advantages thereof, reference is now made to the following description in conjunction with the accompanying drawings, which are described below.

FIG. 1A is a top view of a reaction tray for the preparation of fatty acid esters via reactive distillation, according to an exemplary embodiment.

FIG. 1B is a side cross-sectional view of the reaction tray of FIG. 1A, according to an exemplary embodiment.

FIG. 2 shows an embodiment of the present invention for the preparation of fatty acid esters.

FIG. 3 shows another embodiment of the present invention, further including a pre-treatment process.

FIG. 4 shows another embodiment of the present invention, further including an exemplary separation and/or purification process.

The drawings illustrate only exemplary embodiments of the invention and are therefore not to be considered limiting of its scope, as the invention may admit to other equally effective embodiments. The elements and features shown in the drawings are not necessarily to scale, emphasis instead being placed upon clearly illustrating the principles of exemplary embodiments of the present invention. Additionally, certain dimensions may be exaggerated to help visually convey such principles. In the drawings, reference numerals designate like or corresponding, but not necessarily identical, elements.

### DETAILED DESCRIPTION

The present invention provides a reactive distillation process for the production of fatty acid alkyl esters, including improved biodiesel fuels that meet or exceed the ASTM D6751-10 standard, from feedstocks having any amounts of free fatty acids and glycerides. The invention allows any mixture having both free fatty acids and glycerides to be continuously processed in a single plant.

Preferably, the production of biofuels, such as but not limited to biodiesel fuels, according to the invention occurs on an industrial scale. For example, in a preferred embodiment, production occurs from 500 kg or more of feedstock per day. Alternatively, production may occur on batches of 1,000 kg, 5,000 kg, 10,000 kg or more feedstock per day. Global biodiesel production is estimated at several million tons per year.

As used herein, “biodiesel” or “biodiesel fuel” may be defined as a fuel comprising mono-alkyl esters of long chain fatty acids derived from vegetable oils or animal fats and meeting the requirements of ASTM D6751-10 and/or EN 14214 (2008). As shown in Tables I and II below, under these standards, biodiesel must comprise a number of specific properties, such as but not limited to limited amounts of methanol, sulfur and glycerin, and such properties must be determined according to specific testing methods.

TABLE I
ASTM D6751-10 Specification for Biodiesel

| Property | Testing Method | Limits |
|---|---|---|
| Ca & Mg | EN14538 | 5 ppm (max) |
| Flash Point | ASTM D93 | 93° C. (min) |
| Alcohol Control | | |
| 1) Methanol | EN14110 | 0.2% mass (max) |
| 2) Flash Point | ASTM D93 | 130° C. (min) |
| Water & Sediment | ASTM D2709 | 0.05% vol. (max) |
| Kinematic Viscosity 40° C. | ASTM D445 | 1.9-4.1 mm²/sec |
| Ash Content | ASTM D482 | 0.01% mass (max) |
| Sulfur | | |
| 1) S 15 Grade | ASTM D5453 | 15 ppm (max) |
| 2) S500 Grade | ASTM D5453 | 500 ppm (max) |
| Copper Strip Corrosion | ASTM D130 | No. 3 (max) |
| Cetane | ASTM D613 | 40 (min) |
| Cloud Point | ASTM D2500 | (Report) |
| Carbon Residue 100% sample | ASTM D4530 | 0.05% mass (max) |
| Acid Number | ASTM D664 | 0.3 mg KOH/g (max) |
| Free Glycerin | ASTM D6584 | 0.020% mass (max) |
| Total Glycerin | ASTM D6584 | 0.240% mass (max) |
| Phosphorous Content | ASTM D4951 | 0.001% mass (max). |
| Distillation, T90 AET | ASTM D86 | 343° C. (max) |
| Sodium & Potassium | EN14538 | 5 ppm (max) |
| Oxidation Stability | EN15751 | 3 hrs (min) |
| Cold Soak Filtration | | |
| 1) | Annex to ASTM | 360 s (max) |
| | D6751 | |
| 2) Temp <−12° C. | Annex to ASTM | 200 s (max) |
| | D6751 | |

TABLE II
EN 14214 (2008) Specification for Biodiesel

| Property | Testing Method | Limits |
|---|---|---|
| FAME content | EN 14103 | 96.5% mass (min) |
| Density at 15° C. | EN ISO 3675/EN ISO | 860-900 kg/m³ |
| | 12185 | |
| Kinematic Viscosity | EN ISO 3104 | 3.5-5.0 mm²/sec |
| 40° C. | | |
| Flash Point | EN ISO 2719/EN ISO3679 | 101° C. (min) |
| Sulfur | EN ISO 20846/EN ISO | 10 mg/kg (max) |
| | 20884 | |
| Carbon Residue | EN ISO 10370 | 0.3% mass (max) |
| 100% sample | | |
| Cetane Number | EN ISO 5165 | 51.0 (min) |
| Sulfated Ash | ISO 3987 | 0.02% mass (max) |
| Water | EN ISO 12937 | 500 mg/kg (max) |
| Total Contamination | EN 12662 | 24 mg/kg (max) |
| Copper Band | EN ISO 2160 | Class 1 |
| Corrosion | | |
| Oxidation Stability | prEN 15751/EN 14112 | 6 hrs (min) |
| at 110° C. | | |
| Acid Value | EN 14104 | 0.5 mg KOH/g |
| | | (max) |
| Iodine Value | EN14111 | 120 (max) |
| Linolenic Acid | EN 14103 | 12% mass (max) |
| Methylester | | |
| Polyunsaturated | EN 14103 | 1% mass (max) |
| (>= 4 Double bonds) | | |
| Methylester | | |
| Methanol | EN 1410I | 0.2% mass (max) |
| Monoglyceride | EN 14105 | 0.8% mass (max) |
| Diglyceride | EN 14105 | 0.2% mass (max) |
| Triglyceride | EN 14105 | 0.2% mass (max) |
| Free Glycerine | EN 14105/14106 | 0.02% mass (max) |
| Total Glycerine | EN 14105 | 0.25% mass (max) |
| Group I metals | EN 14108/EN 14109/ | 5 mg/kg (max) |
| (Na + K) | EN 14538 | |
| Group II metals | EN 14538 | 5 mg/kg (max) |
| (Ca + Mg) | | |
| Phosphorus | EN 14107 | 4 mg/kg (max) |

### Biodiesels

In one aspect of the present invention, improved biodiesel fuels prepared according to the present invention are provided. Biodiesels meeting or exceeding each requirement of ASTM D6751-10 and/or EN 14214 (see Tables I and II above) may be produced according to the processes described herein. Moreover, as discussed below, it has surprisingly been found that the disclosed processes allow for the production of biodiesels having substantially improved physical and chemical characteristics as compared to a biodiesel merely meeting the ASTM D6751-10 or EN 14214 specification.

For example, sulfur content of biodiesel fuel is one of many parameters of interest for commercial use. Sulfur is typically present as a result of the use of sulfuric acid catalysts, and can result in increased engine wear and deposits. Additionally, environmental concerns dictate a desired low sulfur content in the biodiesel fuel. Preferably, biodiesels prepared according to the methods provided herein have a sulfur content (as measured by ASTM test method D5453) of less than 500 ppm, more preferably less than 200 ppm, less than 100 ppm, less than 50 ppm, less than 25 ppm, less than 10 ppm, less than 5 ppm, or most preferably less than 1 ppm.

The biodiesel fuel prepared according to the processes provided herein do not contain metallic contaminants such as calcium or magnesium, or contain only miniscule amounts of these contaminants, such as less than 5 ppm. In certain embodiments, these contaminants are minimized due to reactive distillation and/or water washing performed during fat splitting. In other embodiments, these contaminants may be removed by, for example, distillation techniques.

It is preferred that biodiesel fuels prepared according to the present method have relatively high flash points and low methanol content as a result of the unique processes employed. As used herein, “flash point” refers to lowest temperature at which the biodiesel can vaporize to form an ignitable mixture in air. In some embodiments, biodiesels may have a flash point greater than 93° C., more preferably greater than 130° C., even more preferably greater than 140° C., even more preferably greater than 150° C., and most preferably greater than 160° C. as measured according to ASTM D93. Residual methanol in the biodiesel is also desired to be minimized, and is preferably less than 0.2% by weight, more preferably less than 0.18% by weight, less than 0.15%, and most preferably less than 0.10% by weight.

The cetane number (i.e., the measure of the ignition quality and/or delay of the fuel during compression ignition, as measured by ASTM test methods D976, D613, or D4737) of the biodiesels prepared according to the processes disclosed herein may be greater than or equal to 40, greater than or equal to 50, greater than or equal to 55, greater than or equal to 60, greater than or equal to 65, or greater than or equal to 66. Typically, biodiesel fuels with higher cetane numbers (shorter ignition delays) may allow for more efficient operation and/or less emissions.

The acid number of biodiesels prepared according to the processes disclosed herein are substantially lower than those required by the ASTM D6751-10 specification. Generally, higher acid numbers indicate incomplete conversion of the feedstock to fatty acid alkyl esters and/or exposure of the biodiesel to water, either of which may lead to premature failure of engine parts when employed. In one embodiment, the biodiesels produced according to the processes of the instant invention have acid numbers of less than 0.3, less than 0.25, or less than 0.2 mg KOH/g.

The cloud point of a biodiesel is defined as the temperature at which a cloud or haze of crystals appears in the fuel due to the precipitation of components. Because such precipitates may cause engine operability issues, the cloud point determines the climate and season in which the biodiesel fuel may be used. The cloud point may vary significantly depending on the feedstock used, additives, and process steps used to create the biodiesel and ASTM D6751-10 does not specify the required cloud point for biodiesels, but rather mandates that the cloud point be reported to customers. Due to commercial considerations, the cloud point of biodiesel produced according to the methods of the instant invention is preferably less than or equal to 0° C., less than or equal to −2° C., less than or equal to −3° C., less than or equal to −4° C., less than or equal to −5° C., less than or equal to −6° C., less than or equal to −7° C., less than or equal to −8° C., less than or equal to −9° C., less than −10° C., less than −15° C., less than −20° C., less than −25° C., less than −30° C., less than −35° C., less than −40° C., and/or less than −45° C.

Excessive levels of glycerin in biodiesels may lead to a number of problems, such as engine fouling and filter plugging in both storage tanks and fuel systems. In fact, ASTM D6751-10 mandates maximum levels of glycerin in biodiesels, including both a maximum amount of free glycerin and maximum amount of total glycerin. As used herein, “free glycerin” refers to the by-product glycerin that remains in the biodiesel after processing, while “total glycerin” refers to unconverted and partially converted fats and oils.

Free glycerin is a measurement of hydrolysis/methanolysis reaction, specifically of how fatty acids are cleaved from the glycerin backbone. In traditional transesterification processes, fatty acids are cleaved from the glycerin backbone and reacted with methanol in a very fast mechanism. Water and soaps make this reaction difficult and will not only interrupt the reaction mechanism, leaving monoglycerides, diglycerides, and triglycerides (known as bound glycerin) but will also make it difficult for the biodiesel generated to be separated cleanly from the glycerin by, for example, the use of a separation tank. This may leave glycerin and/or glycerides in the final biodiesel product, which may be problematic in combustion engines due to the inherent nature of these materials to plug fuel filters and, potentially, combustion chambers.

The instantly described processes avoid this issue through hydrolysis, distillation, guard bed filtration, and/or the use of an acidic heterogeneous catalyst. For example, the splitting and distillation operations may allow for complete or substantially complete removal of glycerin and glyceride components from the feedstream. In one embodiment, even if glycerin or glycerides pass through the column, the reaction removes water from the reaction zone, the catalyst used may prevent the formation of soaps, and glycerides are simultaneously converted to fatty acid alkyl esters and glycerin. The glycerin may then pass through the column to be separated easily by density (forced or natural), leaving the final biodiesel product with low free and total glycerin (bound glycerin) concentrations.

In certain embodiments, the free glycerin content of biodiesels produced according to the invention is preferably less than 0.020% by weight, more preferably less than 0.018% by weight, less than 0.016% by weight, less than 0.015% by weight, less than 0.010% by weight, less than 0.0075% by weight, less than 0.0050% by weight, and most preferably less than 0.0025% by weight. In exemplary embodiments, the total glycerin present in the biodiesel fuel is preferably less than 0.240% by weight, less than 0.20% by weight, less than 0.10% by weight, less than 0.075% by weight, less than 0.050% by weight, and less than 0.025% by weight.

Water content in the biodiesel fuel produced according the present invention is preferably kept to a minimum as water can lead to a number of problems including a reduction in the heat of combustion, crystal formation at low temperatures and microbial contamination in the form of fungal or bacterial growth, which may lead to corrosion and filter plugging if not properly controlled. Therefore, exemplary biodiesels prepared according to embodiments of the instant invention preferably contain less than 500 ppm, preferably less than 450 ppm, more preferably less than 400 ppm, more preferably less than 300 ppm, more preferably less than 200 ppm, more preferably less than 100 ppm, more preferably less than 50 ppm, more preferably less than 10 ppm, and most preferably less than 5 ppm.

It can be important to define a minimum viscosity of the biodiesel fuel because of power loss due to injection pump and injector leakage. Preferably, the kinematic viscosity of the biodiesel fuel at 40° C. is between about 1.9 and about 4.1 mm²/s.

The Cold Soak Filtration (“CSF”) test is a measurement of the purity of a biodiesel as it goes through a cooling and heating cycle. An exemplary CSF test requires a sample of biodiesel to be cooled for 16 hours and then allowed to warm to atmospheric temperature. The sample is timed during a vacuum filtration process. If a biodiesel product comprises impurities that separate out of solution during the refrigeration process, it may have take longer to pass through the filter. Typically, this can be evidenced by CSF times greater than 360 seconds. Because the instant invention provides for improved biodiesels with less impurities, biodiesels prepared according to methods described herein may have CSF times of less than or equal to 360 seconds, more preferably less than or equal to 220 seconds, less than or equal to 180 seconds, less than or equal to 100 seconds, less than or equal to 90 seconds, less than or equal to 80 seconds, and most preferably less than or equal to 70 seconds.

The acid number of a biodiesel is a relative indicator of the acidic impurities, degradation and/or oxidation of the fuel. The reactive distillation processes employed in the exemplary embodiments of the invention allow for the water generated during the reaction to be removed, preventing stalling and allowing for more complete conversion of fatty acid alkyl esters, approaching 100%. Biodiesels according to the instant invention may have acid numbers of less than or equal to 0.5, less than or equal to 0.3, less than or equal to 0.25, and less than or equal to 0.20.

### General Reactions

Generally, the formation of mono-alkyl esters of long chain fatty acids for use in the preparation of biodiesels, for example, proceeds according to the following esterification reaction:

R¹C(O)OH+R²OH [symbol] R¹C(O)OR²+H₂O

where R¹ is hydrogen or a monovalent organic radical and R² is a monovalent organic radical. As noted previously, fatty acid esters can also be produced by transesterification whereby glycerides are reacted with alcohols in the presence of acid or base catalysts to yield esters and glycerin, for example, according to the following reaction:

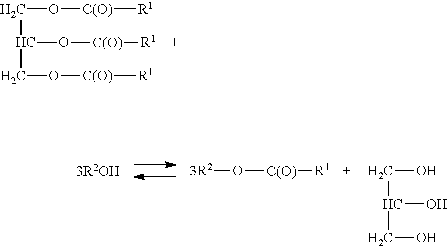

where R¹, and R² are monovalent organic radicals. Production of fatty acid esters by transesterification generally produces a product stream having salts and soaps resulting from treatment with acids and/or bases, and a significant concentration of glycerin.

The process of the present invention employs certain pressures, temperatures, and the vapor stream of the more volatile of the two components, (i.e. the more volatile out of the fatty acid component and the alcohol component), to remove water produced in the esterification reactor, while advantageously not removing a significant quantity of the less volatile component. For this reason it may be important that the boiling point of the vapor mixture exiting the reactor, or of the highest boiling compound present in that vapor mixture, be significantly lower, at the pressure prevailing in the uppermost stage of the reactor, than the boiling point at that pressure of either of the less volatile one of the two components. As used herein with respect to the boiling points, “significantly lower” shall mean that the boiling point difference shall be at least about 20° C., and preferably at least about 25° C., at the relevant operating pressure of the column. In the practice, the more volatile component of the two will frequently be the alcohol component.

### Feedstock Composition

Suitable feedstocks to be employed with processes of the present invention can include any lipid material from a plant or vegetable or an animal, as well as recovered lipids. Suitable examples of lipid materials include, but are not limited to, fats, oils, fatty acids, and glycerides. Suitable fatty acids include, but are not limited to, decanoic acid, dodecanoic acid, tetradecanoic acid, hexadecanoic acid, octadecanoic acid, octadecenoic acid, linoleic acid, eicosanoic acid, isostearic acid and the like, as well as mixtures of two or more thereof. Suitable examples of plants and vegetables include, but are not limited to, soy, rape, canola, camelina, coconut, palm, jatropha, algae, sunflower, and safflower. Suitable examples of animals include, but are not limited to, cows, sheep, rabbits, pigs, whales, and other rendered animals. Suitable examples of recovered lipids include, but are not limited to, yellow grease, brown grease, Dissolved Air Flotation (“DAF”), and other waste or recovery lipid materials. In certain embodiments, the preferred fatty acids (attached to glycerin or in free form) in the feedstocks range from C1 to C22 in chain length and can have no unsaturation sites. In certain alternative embodiments, the fatty acids have a single unsaturation site. In yet other embodiments, the fatty acids have multiple unsaturation sites. In certain exemplary embodiments, the fatty acid chain length is in the range of C14 to C20. The lipids can be in the form of fatty acid, mono-acylglyceride, di-acylglyceride, or tri-acylglyceride and can be composed of different concentrations of each. The free fatty acid content of the feedstock can vary from about 0 to about 100 percent (%). The glyceride content of the feedstock can vary from about 0 to about 100%. Generally, as the amount of the free fatty acid content in the feedstock decreases, the amount of glycerides in the feedstock increases.

### Alcohols

A variety of alcohols may be suitable for use in the processes of the present invention, including any C₁₋₂₄ straight, branched, or cyclic alcohols. In certain exemplary embodiments, the alcohol is a monohydric, aliphatic alcohol. In certain embodiments, the alcohol is a primary, secondary, or tertiary alcohol. Preferably, the alcohol is a C₁₋₆ alcohol. Preferably, the alcohol is selected from t-butanol, isobutanol, methanol, ethanol, propanol, isomers of propanol, isomers of butyl and amyl alcohol, isoamyl alcohol, or mixtures thereof. The alcohols employed are preferably anhydrous, however the presence of a small amount of water may be acceptable for the present reaction. Alcohol vapor serves as a stripping vapor to remove co-produced water in the reactive distillation process of the present invention, and excess alcohol is preferably recovered, purified, and reutilized in the process.

### Catalyst

The esterification and transesterification reactions of the present invention preferably employ a heterogeneous catalyst. By heterogeneous is meant that the catalyst is a solid, whereas the reactants are in gaseous and liquid state, respectively. The catalyst employed is capable of catalyzing both esterification of free fatty acids in the feedstock and transesterification of glycerides therein. The catalyst is preferably solid in nature, and may have acidic functional groups on the surface thereof, or both acidic and basic functional groups.

In certain embodiments, the catalyst is supported on any number of support structures, such as, for example, alumina, silica, magnesium oxide, zirconium oxide, a solgel, or various meal oxides, in order to increase the accessible catalyst surface area and/or to aid catalyst robustness. In alternative embodiments, the catalyst is not supported by a support structure. Suitable examples of catalysts include, but are not limited to, tungstated zirconia, sulfated zirconia, zinc stearate, aluminum dodecatungstophosphate, zinc and lanthanum oxide mixtures, supported or unsupported heteropolyacids, and various hydrotalcite catalysts. In one exemplary embodiment, the catalyst is a heteropolyacid or monovalent cation doped heteropolyacid such as, for example, a composition comprising YₓH₍ₙ₋ₓ₎MX₁₂O₄₀ wherein Y is selected from amongst NH4+, Na+, K+, or Cs+ and wherein X is either W or Mo and wherein M is either P or Si. In another exemplary embodiment, the catalyst is a mixture of zinc oxide and various lanthanum oxides such as, for example, La₂CO₅ and LaOOH, wherein the bulk molar ratio Zn:La may be from about 1:0 to about 4:1. For example, the bulk molar ratio of Zn:LA may be about 1:1, about 2:1, or about 3:1, inclusive. In another embodiment, the catalyst has both Lewis acid and Lewis base sites. The catalyst used on each tray or similar vapor liquid equilibrium affecting device can be a single solid catalyst, or different trays or stages may contain different catalysts. Sufficient catalyst should be used to enable equilibrium or near equilibrium conditions to be established on the tray within the selected residence time at the relevant operating conditions. Additionally, the amount of catalyst on each tray should be maintained such that agitation by the upflowing vapor is sufficient to prevent “dead spots.”

In one embodiment, the amount of catalyst used may be from about 0.1% to about 10% on a weight basis of the feedstock oil. For example, the amount of catalyst used may be about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, or about 10% by weight of the feedstock oil. In the embodiment wherein the catalyst is a mixture of zinc oxide and various lanthanum oxides, the amount of catalyst used may be from about 1% to about 5% on a weight basis of the feedstock oil, or from about 2% to about 3%.

Additionally, the catalyst selected must have sufficient stability (i.e., minimal loss of activity) at the operating temperatures necessary, depending upon the alcohol component of the reaction. For example, if methanol, ethanol, n-propanol, isopropanol, n-butanol, tert-butanol or isobutanol is selected as the alcohol, then the catalyst must be able to be used at temperatures between 120° C. and 140° C.; and must only moderately lose activity in this temperature range. If however, 2-ethyl-hexanol is selected as the alcohol component, then the catalyst should be usable at higher temperatures, such as for example, approximately 150° to 230° C.

### Pre-Treatment

In some embodiments, pre-treatment of the feedstock allows for the removal of numerous contaminants found in feedstock, for example dirt, color bodies, tocopherols, sterols, colorless hydrocarbons, phospholipids, polyethylene, metals, and the like. In certain exemplary embodiments, pre-treatment includes operations such as water degumming, acid degumming, silica treatment, filtration, and/or bleaching. In certain other embodiments, the feedstock is passed through a guard bed to filter out residual contaminants that are detrimental to the catalyst. In yet other embodiments, the feedstock is dearated to remove air, water, and peroxides prior to entry into the reaction vessel.

### Reaction Vessel

The present invention may be practiced in a variety of reaction vessels, preferably in distillation columns having a variety of catalyst arrangements. Preferably, the vessel includes a reaction zone providing means for sufficiently contacting the reactants in the presence of a catalyst. Such means may include a plurality of trays adapted to hold a predetermined liquid volume and a charge of solid catalyst. Means are provided on each tray to allow the glycerin to be separated and the liquid phase containing triglycerides, free fatty acids, and fatty acid alkyl esters to pass down the column and into the next tray, while still retaining the solid catalyst in the tray. In addition, means are provided to allow vapor to enter the tray from below and agitate the mixture of liquid and solid catalyst. The less volatile component of the alcohol and the feedstream containing lipids is supplied in liquid phase to the top of the column while the more volatile component is supplied in the vapor phase to the bottom of the column. Accordingly, the alcohol and the feedstream are passed in countercurrent relation through the reaction zone that is maintained under conditions suitable for the esterification of free fatty acids and the transesterification of glycerides. The vapor phase comprising the less volatile component and co-produced water is recovered from the upper portion of the reactor, while the fatty acid alkyl ester stream is collected from the lower portion of the reactor. In this manner the alcohol acts as a stripping vapor to remove the co-produced water. In certain exemplary embodiments, alcohol is separated from the volatiles mixtures and can then be reused in the reaction zone. In one embodiment, a catalyst can be added and removed from the reaction vessel selectively. For example, when using a plurality of trays, a catalyst can be switched from one tray without removing catalyst from other trays.

In certain embodiments, the catalyst can be a fixed-bed catalyst. In a fixed bed arrangement, the reaction vessel can be operated as a trickle column of which about 30 to 60 vol %, preferably about 50 vol % may be utilized by the stripping gas as free gas space, whereas about 30 to 50 vol %, preferably 40 vol % of the column may be occupied by solid substance, i.e. the fixed-bed catalyst. The remaining reaction space, preferably about 10 vol % or less, may be occupied by the trickling liquid. When using a fixed bed, the residence time of the liquid phase can be adjusted by the stripping gas velocity. The residence time of the liquid phase is high with higher velocities of the stripping gas volume. Generally, the stripping gas throughput can be adjusted in a wide range without having an adverse effect on the course of process.

### Post-Treatment

The product streams from the reaction vessel can be processed downstream using certain unit operations. The unit operations can be set up in parallel or in series, and can include cooling, forced or settling decantation, one or more flashing units, distillation, fuel-additive addition, and final conditioning. The downstream processing allows for the intermediate product to be refined to high quality fatty acid alkyl esters and technical grade glycerin. Excess alcohol can also be recovered, purified, and then reutilized in the esterification and transesterification reactions. Purification of alcohol can be performed by distillation and separation operations.

### Reaction Conditions

The esterification and transesterification conditions used in a reaction vessel according to the present invention will normally include the use of elevated temperatures up to about 200° C. Typically, the reaction conditions are determined based upon the boiling point of the less volatile component, typically the alcohol component. Generally, the esterification and transesterification reactions may be conducted at a temperature in the range of from about 110° C. to about 250° C., preferably in the range of from about 150° C. to about 200° C. The particular operating temperature of the reactions is also determined based on the thermal stability of the catalyst, the kinetics of the reaction and the vapor temperature of the less volatile component at the relevant inlet pressure. Typical operating pressures at the inlet of the column reactor may range from about 60 pounds per square inch (psi) to about 200 psi. Additionally, the liquid hourly space velocity through the column reactor may range from about 0.1 hr⁻¹ to about 0.5 hr¹. In one embodiment, the ester product remains in the liquid phase while being processed.

Depending on the feedstock, a number of reactions can occur in the reaction zones of the reaction vessel. These reactions include, but are not limited to, transesterification of glycerides, esterification of free fatty acids, glycerolysis of free fatty acid with glycerin, glycerolysis of glyceride to glycerin, polymerization of glycerin, and conversion of glycerin to acrolein.

In the transesterification of glycerides process, the glycerides are separated into free fatty acids and glycerin and alcohol rapidly joins the free fatty acid to generate a fatty acid methyl ester. The glycerin backbone, which was acylated, becomes free and is known as free glycerin. Since glycerin inhibits the ability of the catalyst to contact both methanol and glyceride, the glycerin is preferably continuously removed from the reaction zone and can be further refined during post-treatment.

Water is produced during the esterification of free fatty acids, and must be removed in order to continuously drive the reaction. In the processes of the present invention, water is volatized upon being generated due to the operating conditions of the reaction vessel, thus removing any water that limits the production of fatty acid alkyl esters from free fatty acids.

In the reaction vessel, glycerolysis of the free fatty acids with the glycerin produced from the transesterification reaction can occur. The free fatty acids can link back to the glycerin backbone by a reversion process to form mono-acylglycerides, di-acylglycerides, and tri-acylglycerides. However, this reaction may take several hours, whereas in the present invention the tray residence time is preferably less than about 1.5 hr. In addition, for every free fatty acid molecule that links to the glycerin backbone, one molecule of water is typically generated, which can be volatized and removed through the top of the tray.

Glycerolysis of glyceride with glycerin can also occur in the reaction vessel when excess glycerin contacts glycerides. An interesterification reaction occurs in which one or more of the free fatty acid molecules on the glyceride can link to a free glycerin molecule, thus producing a mono-acylglyceride or di-acylglyceride molecule. The water that is also produced can be volatized and removed, or can be absorbed by the open position on the glyceride molecule from which the free fatty acid was removed.

If held at reaction conditions for excessive periods of time, the glycerin produced in the reaction vessel can polymerize in a condensation reaction, which would link a glycerin molecule to another glycerin molecule while producing water, and a small portion of the glycerin would be cleaved from the polymerized material to generate acrolein. The processes of the present invention aim to remove the glycerin in the shortest time frame that allows for sufficient reaction conversion and removal of glycerin from the reactant stream by decantation. Due to the nature of competing reactions, it is preferable to minimize polymerization and acrolein production during this process.

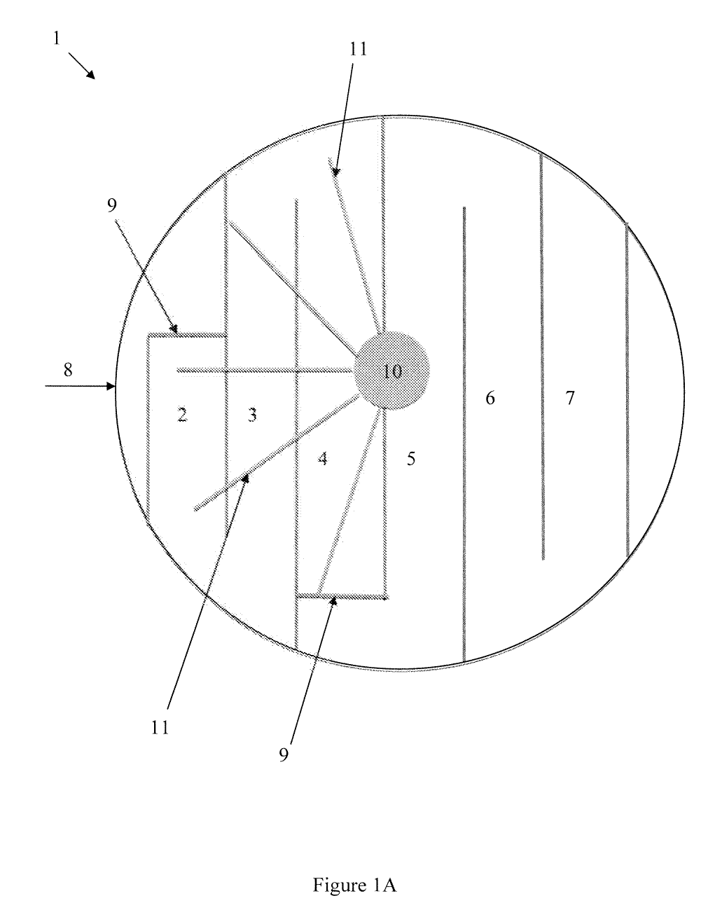

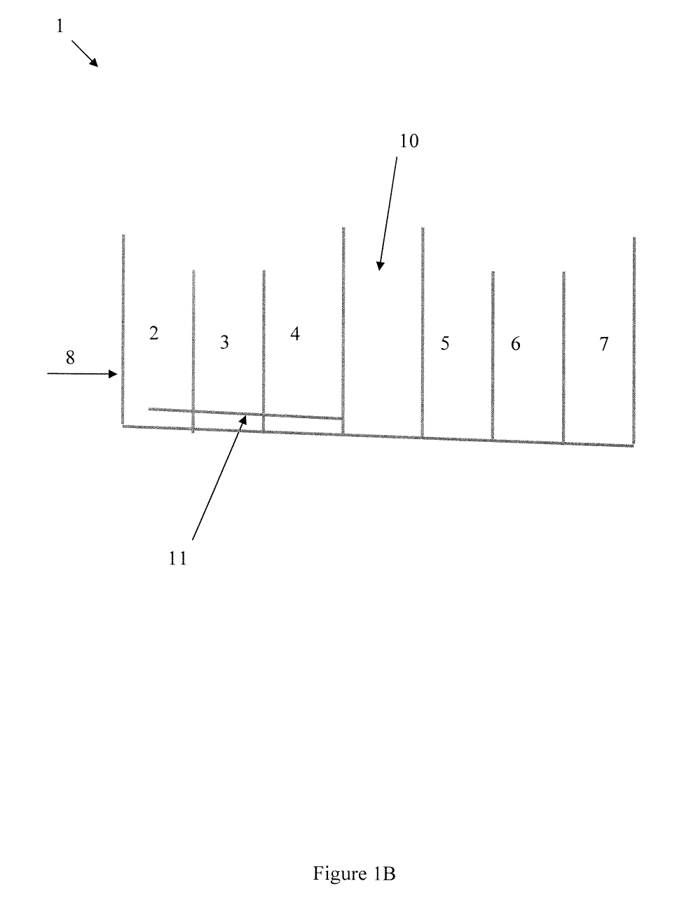

Referring now to FIGS. 1A and 1B, there is provided an exemplary embodiment of a reaction tray 1 of a column (not shown) having from about 5 to about 20 reaction trays for the simultaneous transesterification and esterification of a feedstock containing both glycerides and free fatty acids. In certain exemplary embodiments, the column operates at a temperature in the range of from about 150° C. to about 200° C., and at a pressure in the range of from about 60 psi to about 200 psi. In certain embodiments, the liquid hourly space velocity through the column may range from about 0.2 hr⁻¹ to about 1 hr⁻¹ based on the feedstream.

FIG. 1A is a top view of the reaction tray 1, and FIG. 1B is a side cross-sectional view of the reaction tray 1. In one exemplary embodiment, the reaction tray 1 is cylindrical-shaped and includes six channels 2-7, whereby adjacent channels 2-3, 3-4, 4-5, 5-6, and 6-7 are aligned so as to allow material to flow from one channel to the next. In certain exemplary embodiments, the reaction tray 1 has a diameter of about 20 feet, more particularly, about 15 feet, or about 14 feet, and each of the channels 2-7 has a width of less than about 2 feet and a height of about 3.5 feet. In certain exemplary embodiments, channels 2-4 form a reaction zone and include a catalyst, and channels 5-7 form a decanting area. A feedstream 8 is supplied to the reaction tray 1 and enters the channel 2. In certain exemplary embodiments, the feedstream 8 includes free fatty acids and oils and/or fats. The feedstream 8 reacts with alcohol in the presence of the catalyst as it moves through channels 2-4 of the reaction zone. The catalyst can be any catalyst described in the present application. In certain embodiments, the catalyst is free floating and contained in the reaction zone by filters 9.

The reaction tray 1 also includes a vapor chimney 10 positioned in about a center thereof, between channels 4 and 5. Alcohol enters from a bottom of the reaction tray 1, into a plurality of sparge arms 11, and enters the reaction zone. Generally, the alcohol is in vapor phase. In certain exemplary embodiments, the residence time of the feedstream 8 in the reaction zone with the alcohol is in the range of about 10 minutes to about 30 minutes. In certain exemplary embodiment, 30 MMgal/yr of biodiesel can be produced under these residence times and operating conditions. In certain embodiments, the catalyst loading is in the range of about 500 to about 1000 pounds per reaction area to ensure proper contact of the catalyst and the reactants. Generally, the catalyst includes a number of active sites for the reaction conversion such that the product exiting a final reaction tray will meet the specifications of ASTM 6751-10 biodiesel regulations.

After the feedstream 8 exits channel 4 of the reaction zone, the liquid reactants and products enter channels 5-7 of the decanting area, while the catalyst remains in the reaction zone. In certain exemplary embodiments, the bottom of the reaction tray 1 is angled to ensure flow from the reaction zone to the decanting area. In certain embodiments, the products reside in the decanting area for a time in the range of about 30 minutes to about 1 hour. Materials having a lower density (s.g. ˜0.90), such as the fatty acid alkyl esters, free fatty acids, and glycerides, will float to the top of the channels 5-7. Materials having a higher density (s.g. ˜1.2), such as the glycerin, will settle towards the bottom of the channels 5-7. Moreover, any volatile materials, such as water generated from the esterification of free fatty acids or glycerolysis reactions, or any reactant materials, such as alcohol, will remain in the vapor phase due to the operating conditions in the column, and will be subsequently removed through the top of the reaction tray 1. In this embodiment, after the liquid reactants and products have moved through the channels 5-7 of the decanting area, the glycerin exits the bottom of the reaction tray 1 such as via the use of a weir or similar equipment, and may be sent for further refinement outside of the reaction column.

In another embodiment, glycerin may be separated from the fatty acid alkyl esters, free fatty acids, and glycerides via electrostatic coalescence. For example, the stream comprising fatty acid alkyl esters, free fatty acids, glycerin, and glycerides may be caused to pass through an electric field sufficient to induce electrostatic coalescence of the glycerin. In one embodiment the electric field may be a DC electric field between two conductive surfaces serving as electrode surfaces. The strength of the DC electric field may be from about 1 kV/inch to about 10 kV/inch, from about 2 kV/inch to about 8 kV/inch, or from about 4 kV/inch to about 6 kV/inch. In one embodiment, the electrode surfaces may comprise, consist, or consist essentially of the channels 5-7 of the decanting area. In another embodiment, a stream comprising fatty acid alkyl esters, free fatty acids, glycerin, and glycerides can be caused to pass between adjacent electrode surfaces and thereby through an electric field.

In one embodiment, electrostatic coalescence may be accomplished within the reaction column. In this embodiment, electrostatic coalescence may be employed in any number of reaction trays of the reaction column, including a single reaction tray, one or more reaction trays, or all reaction trays, For example, if a reaction column comprises 10 reaction trays, electrostatic coalescence may be employed in any combination of trays 1, 2, 3, 4, 5, 6, 7, 8, 9, and 10. In certain embodiments wherein glycerin separation is caused and/or accelerated by electrostatic coalescence, glycerin can exit the bottom of the reaction tray such as via the use of a weir or similar equipment, and may be sent for further refinement outside of the reaction column. In other embodiments, the electrostatic coalescence may be accomplished outside the reaction column, with the resulting stream comprising fatty acid alkyl esters, free fatty acids, and glycerides being reintroduced into the reaction column after removal of the glycerin.

Various types of electric circuitry, power supplies, and provision for grounding of appropriate surfaces may be employed to generate the desired electric field. While not wishing to be bound by theory, it is believed that the electric field induces formation of larger glycerin droplets, thereby accelerating separation of glycerin from the stream comprising fatty acid alkyl esters, free fatty acids, glycerin, and glycerides.

In any event, once the glycerin is separated out, the free fatty acids, fatty acid alkyl esters, and glycerides are charged to the next reaction tray, positioned below reaction tray 1, for further reaction and processing. As the reactant and product stream travels down the column, the amount of reactants, free fatty acids and glycerides, generally decrease, the amount of by-products, water and glycerin, also decrease, and the amount of product, fatty acid alkyl esters, generally increases such that only minor refinements are required to ensure that the product meets the ASTM 6751-10 specifications.

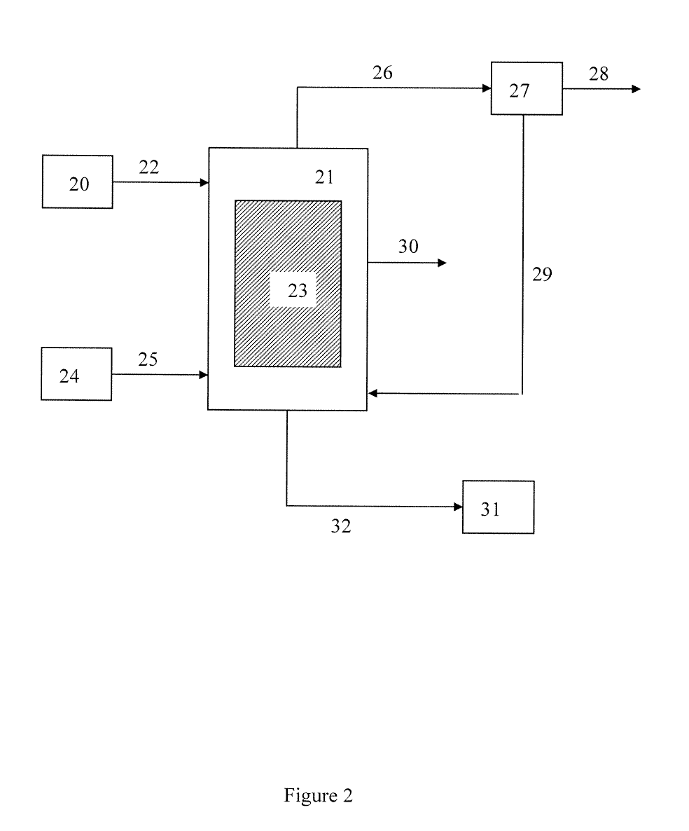

Referring now to FIG. 2, there is provided an embodiment of a process for the simultaneous transesterification and esterification of a feedstock containing both glycerides and free fatty acids. A feedstock 20 having both glycerides and free fatty acids is supplied to column 21 via line 22. If the feedstock 20 is the less volatile component (compared to the alcohol), then feedstock 20 is supplied to the upper portion of the column 21, preferable above a reaction zone 23. An alcohol 24, preferably methanol, is supplied to the column 21 via line 25. If the alcohol 24 is the more volatile component (compared with the feedstock 20), then the alcohol 24 is supplied to the bottom of column 21, preferably below the reaction zone 23.

The reaction zone 23 preferably includes a plurality of reaction trays, similar to reaction tray 1 (FIGS. 1A-1B), or structured packing which includes a heterogeneous catalyst as described previously. If structured packing is employed, preferably achieving the same vapor-liquid contact as is accomplished with trays. One of skill in the art can determine the equivalent size and type of packing for a given number of trays in a distillation column.

The alcohol 24 is introduced at the bottom of the column 21 as a vapor, traveling upward through the trays, and preferably contacting the free fatty acids and glycerides in the reaction zone in the presence of the appropriate catalyst. Column 21 preferably includes means for heating the alcohol 24 to produce a vapor stream. The alcohol stream exits column 21 via line 26, preferably including at least a portion of the water produced by the esterification reaction. The alcohol stream can be supplied to an alcohol/water separation unit 27, which separates the stream into a water-rich stream 28 and an alcohol rich stream 29, which can be recycled to the distillation column 21.

Transesterification of the glycerides in the feedstock 20 yields glycerin, which is removed from each reaction tray within the column 21 via line 30. In certain exemplary embodiments, glycerin is removed from each reaction tray and combined to feed into line 30. In alternative embodiments, glycerin is removed from each reaction tray and removed from the column 21 via a plurality of lines corresponding to the number of trays present in the column 21. Accordingly, the column 21 yields a product stream 31 that exits as the bottoms liquid via line 32 and includes fatty acid alkyl ethers, and meets ASTM 6751-10 specifications.

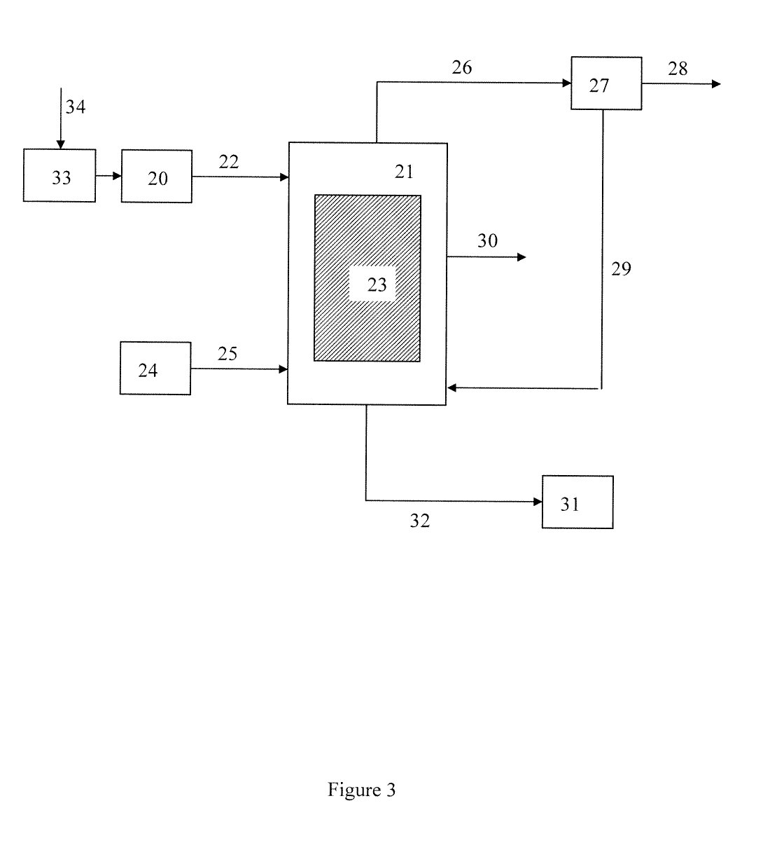

Referring to FIG. 3, the embodiment according to FIG. 2 is provided, further including a pre-treatment unit 33, to which the feedstock is introduced via line 34. Pre-treatment of the feedstock allows for the removal of numerous contaminants found in feedstock, for example dirt, colored compounds, polyethylene, and metals.

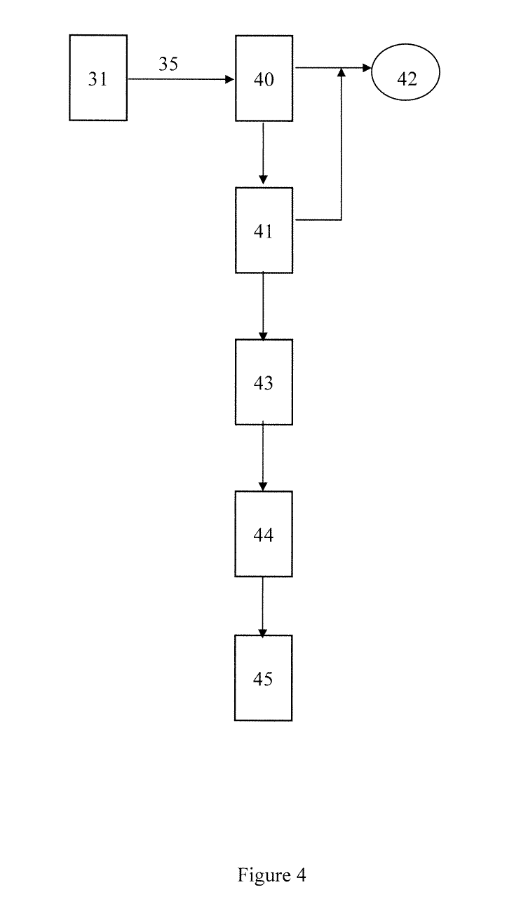

Referring to FIG. 4, an embodiment is provided including post-treatment operations, to which the product stream 31 (FIG. 2) is introduced via line 35. The product stream 31 may be subjected to any number of flash processes, such as but not limited to at least one atmospheric flash process 40 and/or at least one vacuum flash process 41, to remove water and/or volatile materials 42 present in the product stream. Generally, the flash processes 40, 41 of the instant invention allow for the passing of a fatty acid alkyl ester product stream through a vessel having enough volume to allow for disengagement of water and/or volatile material 42 from the liquid product stream, while the temperature of the product stream is raised above the boiling point of the water and/or volatile material 42. In this way, the water and/or volatile materials 42 may be removed from the product stream as gases.

In exemplary embodiments, an atmospheric flash process 40 may be performed at a pressure at or about atmospheric pressure (e.g., about 1 bar or about 1 atm), while the vacuum flash process 41 may be performed at a pressure of between about 0.10 bar to about 0.50 bar. In some embodiments, the vacuum flash process 41 may be performed about 0.15 bar, about 0.20 bar, about 0.25 bar, about 0.30 bar, about 0.35 bar, about 0.40 bar, about 0.45 bar or about 0.50 bar. Moreover, although both the atmospheric flash process 40 and vacuum flash process 41 may raise the temperature of the product stream 31 to from about 190° C. to about 225° C. (depending on the boiling point of the water and/or volatile materials to be separated), because of the difference in pressure, the vacuum flash process 41 may create a more aggressive condition to drive the remaining water and/or volatile materials 42 left after an atmospheric flash process 40. This may be necessary to assure compliance of the resulting biodiesel with the ASTM D6751-10 specification.

In one exemplary embodiment, once the temperature of the product stream has been rapidly increased during a heat treatment process (not shown) and/or one or more flash processes 40 and 41, the product stream may be subjected to a cold treatment process 43 to prevent the fatty acid alkyl esters from breaking down. In an exemplary cold treatment process 43, the temperature may be rapidly decreased from about 200° C. down to a temperature of about 20° C., about 25° C., about 30° C., about 35° C., about 40° C., about 45° C., about 50° C., about 55° C., about 60° C., about 65° C., or about 70° C. by, for example, the use of an interchanger and/or one or more cold water streams. As used herein, the term “rapidly” may mean that the respective increase or decrease in temperature is incurred in about 0.1 seconds, about 0.2 seconds, about 0.3 seconds, about 0.4 seconds, about 0.5 seconds, about 1 second, about 1.5 seconds, about 2 seconds, about 3 seconds, about 4 seconds, about 5 seconds, about 10 seconds, about 30 seconds, about 1 minute, about 2 minutes, about 3 minutes, about 4 minutes, or about 5 minutes.

Once the product stream is cooled, it may be subjected to an additive process 44, wherein any number of biodiesel additives may be added thereto such that the final biodiesel product meets or exceeds the ASTM D6751-10 specification. Additives thought to be useful in preparing biodiesels include but are not limited to cloud point additives, oxidation stability additives, anti-microbial additives, corrosion inhibitors and cetane additives. It will be appreciated that both the type and amount of additive employed will depend on any number of factors, such as but not limited to the specific feedstock employed and/or the desired or required biodiesel end product. In one embodiment, anti-microbial additives are employed in an amount of from about 50 ppm to about 2000 ppm. In another exemplary embodiment, anti-microbial additives, oxidation stability additives, and corrosion inhibition additives are employed in effective amounts, such as but not limited to from about 50 ppm to about 2000 ppm. It will be appreciated that, although additives may be included in the product stream before cooling, it is preferred to employ such additives after cooling as to prevent degradation and/or loss of activity of the additives.

Once the product stream is cooled, it may be retained in a vessel or tank such that it may be easily stored and/or shipped. In certain embodiments, the product stream may be subjected to a conditioning process 45 to ensure that the product stream meets or exceeds the ASTM D6751-10 specification. In one embodiment, the conditioning process 45 comprises a nitrogen blanketing process, wherein nitrogen gas is slowly charged into the vessel or tank holding the product stream such that the pressure in the vessel is maintained at a slightly higher pressure than the outside atmosphere. This process ensures that oxygen is not present in the final fuel and/or that moisture may not enter the vessel or tank holding the product stream. In another embodiment, the conditioning process 45 comprises physically turning or adjusting the vessel or tank such that the biodiesel product remains homogenous in nature without striation.

Although not shown, it is contemplated additional processes may be included to further purify the biodiesel process. In one such process the biodiesel product may be passed through a bag filter adapted to remove particles having a size of from about 1 μm and/or larger. Such particles may include broken catalyst or catalyst attrition residue, metals, and other miscellaneous materials.

In one embodiment, a feedstock having RBD oil is optionally subjected to pre-treatment operations prior to being directed into a reactive distillation unit. The RBD oil is converted to a high quality fatty acid methyl ester biodiesel and a technical grade glycerin product after further downstream processing. Excess alcohol from the reactive distillation process is recovered, purified, and reutilized in the column. The fatty acid methyl ester product is a biodiesel that meets or exceeds ASTM 6751-10 specifications and EN 14214 specifications. The glycerin product meets technical grade glycerin specifications and is suitable for sale in the glycerin market.

In another embodiment, a suitable feedstock comprises crude vegetable oil feedstock having high phosphorous <1000 ppm, unsaponifiable matter of <2%, sulfur <15 ppm, other impurities <1%, and a free fatty acid content between 0 wt % and 30 wt %. The feedstock is subjected to refining, filtration, and dearation to remove phosphatides, metals, soaps, and the like. The resulting pre-treated feedstock comprises phosphorous <10 ppm and preferably <3 ppm, unsaponifiable matter of <1% and preferably <0.5%, sulfur <10 ppm, and other impurities <0.1%. The refined feedstock is then subjected to reactive distillation over a solid catalyst to convert both free fatty acids and glycerides to fatty acid alkyl esters. Finally, the reactive distillation product is subjected to post-treatment comprising separation, heat treatment, flashing, additive addition, and conditioning to produce a high quality fatty acid alkyl ester and technical grade glycerin. Excess alcohol is recovered, purified, and reutilized in the reactive distillation.

In yet another embodiment, a feedstock having a high free fatty acid content of greater than about 30 wt % is suitable for processing using the reactive distillation column of the present invention. The feedstock further comprises <3% unsaponifiable matter, <1% polymerized material, and other minor constituents subjected to pre-treatment for the purpose of refining, filtration, and dearation to remove metals, sulfur, and other minerals. The refined feedstock is then introduced to the reactive distillation unit wherein both free fatty acids and glycerides are converted to fatty acid alkyl esters by reaction with methanol over a solid catalyst. The crude reaction mixture is subjected to post-treatment comprising separation, heat treatment, flashing, additive addition, and conditioning to produce a high quality fatty acid methyl ester biodiesel and technical grade glycerin. Excess alcohol is recovered, purified, and reutilized in the reactive distillation.

In some embodiments, the pre-treatment, reactive distillation, and post-treatment units are operated in such a manner that the resulting fatty acid alkyl ester product meets United States and European biodiesel specifications. In other embodiments, the resulting product is made to meet additional specifications in addition to biodiesel.

In a preferred embodiment, the pre-treatment, reactive distillation, and post-treatment are performed on an industrial scale of at least 500 kg or more of feedstock per day. More preferably, the invention is practiced on 1,000 kg, 5,000 kg, 10,000 kg or more of feedstock per day.

While continuous operation is the preferred mode for the invention, it will be recognized that the processes described herein can be performed in a batch or continuous manner, depending on the volume of feedstock to be treated.

It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment forms no part of the present invention and is in accordance with conventional chemical engineering practice.

Modifications and variations of the present invention relating to a the selection of fatty acid feedstocks, alcohols and catalysts may be practiced by those skilled in the art from the foregoing detailed description of the invention. Such modifications and variations are intended to come within the scope of the appended claims.

We claim:

1. A process for creating a biodiesel fuel meeting or exceeding the ASTM D6751-10 Specification, the process comprising:
reactively distilling a feedstream comprising fatty acids and glycerides with an alcohol feedstream to produce a fatty acid alkyl ester product stream;
separating glycerin from the product stream;
increasing the temperature of the product stream to a temperature such that water and/or at least one volatile material is vaporized and removed; and
incorporating at least one biodiesel additive into the product stream such that the product stream is converted into a biodiesel meeting or exceeding the ASTM D6751-10 Specification.

2. The process of claim 1, wherein said separating step comprises separating the glycerin from each reaction tray within a distillation column.

3. The process of claim 1, wherein said separating comprises passing the product stream through an electric field sufficient to induce electrostatic coalescence of the glycerine.

4. The process of claim 1, wherein the at least one volatile material is selected from the group consisting of alcohols, color bodies, tocopherols, sterols, colorless hydrocarbons, phospholipids and metals.

5. The process of claim 1, further comprising subjecting the product stream to at least one flash process comprising rapidly increasing the temperature of the fatty acid alkyl ester stream to from about 190° C. to about 225° C. and removing water and/or at least one volatile material.

6. The process of claim 5, further comprising rapidly cooling the product stream to a temperature of from about 20° C. to about 70° C.

7. The process of claim 5, wherein the at least one flash process is an atmospheric flash process performed at about atmospheric pressure.

8. The process of claim 5, wherein the at least one flash process is a vacuum flash process performed at a pressure of from about 0.10 bar to about 0.50 bar.

9. The process of claim 1, wherein the at least one biodiesel additive is selected from the group consisting of cloud point additives, oxidation stability additives, anti-microbial additives, corrosion inhibitors and cetane additives.

10. The process of claim 1, further comprising storing the biodiesel in a vessel, wherein nitrogen gas is charged into the vessel such that the pressure in the vessel is higher than the outside atmosphere.

11. The process of claim 10, further comprising physically adjusting the vessel such that the biodiesel remains homogenous in nature without striation.

12. A process for preparing biodiesel meeting or exceeding biodiesel standard ASTM D6751-10 from a feedstock comprising fatty acids and glycerides, the process comprising:
continuously introducing an alcohol vapor feedstream to a reaction vessel, the reaction vessel comprising a reaction zone and a decanting area;
continuously introducing a feedstock comprising fatty acids and glycerides to the reaction vessel;
catalytically reacting the fatty acids and glycerides with the alcohol vapor in the reaction zone within the reaction vessel to produce fatty acid ester, glycerin, and water, said reaction zone containing a heterogeneous catalyst;
stripping said water from the reaction vessel with the alcohol vapor;
separating said glycerin from the reaction vessel in the decanting area of the reaction vessel;
collecting a fatty acid alkyl ester product stream; and
incorporating at least one biodiesel additive into said fatty acid alkyl ester product stream such that the product stream is converted into a biodiesel meeting or exceeding the ASTM D6751-10 Specification.

13. The process of claim 12, further comprising separating the water from the alcohol vapor and recycling said alcohol to the reaction vessel.

14. The process of claim 12, wherein said separating glycerin comprises passing the glycerin through an electric field sufficient to induce electrostatic coalescence of the glycerin.

15. The process of claim 12, wherein the at least one biodiesel additive is selected from the group consisting of cloud point additives, oxidation stability additives, anti-microbial additives, corrosion inhibitors and cetane additives.

16. The process of claim 12, wherein the catalyst is selected from the group consisting of tungstated zirconia, sulfated zirconia, zinc stearate, aluminum dodecatungstophosphate, zinc and lanthanum oxide mixtures, heteropolyacids, and hydrotalcite catalysts.

17. The process of claim 12, wherein the catalyst is capable of catalyzing both transesterification of glycerides and esterification of fatty acids.

18. The process of claim 12, wherein the catalyst is on a support.

19. The process of claim 18, wherein the support comprises solgel or a metal oxide.

20. The process of claim 12, further comprising pre-treatment of the feedstream prior to introduction of the feedstream into the reaction vessel.

21. A reaction vessel for preparing a fatty acid alkyl ester from a feedstock comprising fatty acids and glycerides, the reaction vessel comprising:
a housing comprising a first plurality of channels and a second plurality of channels, wherein each of the channels are substantially parallel to one another, wherein the channels are configured such that a flowpath exists between adjacent channels;
a catalyst positioned within the first plurality of channels, wherein the catalyst facilitates transesterification of glycerides and esterification of fatty acids to form said fatty acid alkyl ester.

22. The reaction vessel of claim 21, wherein the catalyst is selected from the group consisting of tungstated zirconia, sulfated zirconia, zinc stearate, aluminum dodecatungstophosphate, zinc and lanthanum oxide mixtures, heteropolyacids, and hydrotalcite catalysts.

23. The reaction vessel of claim 21, wherein said catalyst is on a support.

24. The reaction vessel of claim 23, wherein said support comprises solgel or a metal oxide.

25. The reaction vessel of claim 21, further comprising a vapor channel providing an alcohol vapor feedstream to the reaction vessel.

26. The reaction vessel of claim 21, wherein the first plurality of channels provides a reaction zone and the second plurality of channels provides a decanting area.

27. The reaction vessel of claim 26, wherein the decanting area comprises an electrostatic coalescer.
